(19) United States
(12) Patent Application Publication
(10) Pub. No.: US 2017/0068014 A1
(43) Pub. Date: Mar. 9, 2017

(54) SYSTEMS AND METHODS FOR A COMPOSITE MAGNETIC FIELD SENSOR FOR AIRBORNE GEOPHYSICAL SURVEYS

(71) Applicant: CGG SERVICES SA, Massy (FR)

(72) Inventors: Philip MILES, Rockwood, Ontario (CA); Jason BERRINGER, Rockwood (CA); Adam SMIAROWSKI, Toronto, Ontario (CA)

(21) Appl. No.: 15/120,628

(22) PCT Filed: Feb. 26, 2015
(86) PCT No.: PCT/IB2015/000499

§ 371 Date: Aug. 22, 2016

Related U.S. Application Data
(60) Provisional application No. 61/945,851, filed on Feb. 28, 2014.

(51) Int. Cl. G01V 3/165; G01V 3/16

(52) U.S. Cl. CPC G01V 3/165; G01V 3/16

(57) ABSTRACT

Systems and methods for a composite magnetic field sensor is disclosed. The electromagnetic survey system includes a first receiver configured to sense signals in a first spectrum based on sensing a magnetic field. The system includes a second receiver configured to sense signals in a second spectrum based on sensing a time rate of change of the magnetic field. The second spectrum has a frequency range higher than the first spectrum. The system further includes a transmitter configured to transmit a specified waveform and a control system configured to control the transmitter to transmit the specified waveform. The control system is also configured to receive signals sensed by the first receiver, receive signals sensed by the second receiver, and store the signals received from the first receiver and the signals received from the second receiver.

### CROSS-REFERENCE TO RELATED APPLICATION

This application claims the benefit under 35 U.S.C. §119(e) of U.S. Provisional Application Ser. No. 61/945,851 filed on Feb. 28, 2014, which is incorporated by reference in its entirety for all purposes.

### TECHNICAL FIELD

The present disclosure relates generally to geophysical electromagnetic exploration and, more particularly, to systems and methods for a composite magnetic field sensor for airborne geophysical surveys.

### BACKGROUND

Electromagnetic (EM) surveying methods measure the response of subsurface formations to the propagation of naturally or artificially generated electromagnetic fields. Primary electromagnetic fields are generated by passing alternating current or pulsing a current through a “transmitter” that includes an electrically conducting wire or tube, which may be wrapped around a core made of some magnetically permeable material. Use of a continuously alternating current is referred to as frequency-domain EM methods while time-domain EM or transient EM methods use a periodically pulsed current, which has definitive ON and OFF time periods. During the ON-period, current is applied through the transmitter wires and then switched off, after which there is an OFF-period where no current is applied and generally, where measurements are performed. In both cases, the time-variation of current passing through the transmitter produces a time-varying magnetic field in a large vicinity around the transmitter. A transmitter may be a small coil made up of many turns of wire or a large loop of wire with one or multiple turns. Subsurface formations respond to the propagation of time-varying natural or artificial electromagnetic fields with the generation of secondary electrical currents by the process of electromagnetic induction (which is the production of a voltage across a conductor when it is exposed to a varying magnetic field) giving rise to secondary electromagnetic fields. The primary and secondary electromagnetic fields may be detected by a “receiver.”

A receiver may measure the time-variation of the magnetic field from these currents (for example, by measuring dB/dt, the time derivative of the magnetic field) or may measure the magnetic field itself (a B-field sensor). In EM surveys, the B-field is the magnetic field component of the electromagnetic field. The B-field may be measured directly or, more commonly, calculated by integrating the time rate of change, dB/dt, of the magnetic field as measured with a receiver. Magnetometers measure the magnetic field directly while induction coil sensors measure dB/dt.

The electromagnetic field travels from the transmitter to the receiver via paths both above and below the surface of the earth. In the presence of a conducting body or earth material such as soils, rocks, ores or other conducting material, the magnetic component of the electromagnetic field penetrating the subsurface induces time-varying currents, or eddy currents, to flow in the conducting body. The eddy currents generate their own electromagnetic field (referred to as secondary electromagnetic field) that travels to the receiver. The receiver then undergoes a response to the arriving primary and secondary electromagnetic fields so that the response differs in both phase and amplitude from the response to the primary electromagnetic field alone. Differences between the transmitted and received electromagnetic fields reveal the presence of the conducting body or conducting material and provide information on the conducting body's geometry and electrical properties.

Because electromagnetic fields propagate through air, there is no need for physical contact of either the transmitter or receiver with the earth's surface. EM surveys can thus proceed much more rapidly than galvanic method surveys, where ground contact is required. More importantly, one or both of the transmitter and receiver can be mounted in or on or towed behind an aircraft. Airborne EM surveys may be used in prospecting for conductive ore bodies and many other geological targets due to their speed and relative cost-effectiveness.

The electromagnetic response from subsurface materials or bodies is dependent on the electrical conductivity of the material or body. Ore bodies or other structures, such as layers that have low electrical conductivity, may still provide an electromagnetic response. Generally, sensitivity to highly conductive materials is improved using a measurement of the magnetic field, rather than its time derivative. These materials have slower secondary magnetic field decay times resulting in lower frequency signals of longer time duration. As such, the magnetic field is often estimated or calculated based on measurements from an induction coil receiver in an attempt to increase sensitivity to highly conductive material or decrease sensitivity from relatively poor conductors, which have a higher frequency signal, or other noise sources. For example, in EM surveys, an induction coil measuring time-rate of change of the magnetic field is usually employed and a digital operation is performed to estimate the magnetic field. Such calculations are inherently limited due to the poor low-frequency sensitivity of induction coils.

Thus, in summary, EM surveying uses the principle of electromagnetic induction to measure the electrical conductivity of the subsurface. In the case of a frequency-domain EM survey, an alternating electric current of known frequency and magnitude is passed through a transmitter creating a primary electromagnetic field in the space surrounding the coil, including underground. The time-varying electromagnetic fields induce a secondary current in naturally occurring underground conductors or structures, which results in an alternating secondary magnetic field that is sensed by the receiver. The secondary field is distinguished from the primary field by a phase lag. The ratio of the magnitudes of the primary and secondary currents is proportional to the terrain conductivity. The depth of penetration of the electromagnetic field into the subsurface is governed by the subsurface electrical conductivity and transmitter excitation frequency and coil separation and orientation.

In the case of a time-domain EM survey, the same principle of electromagnetic induction is used to measure the electrical conductivity of the subsurface. A pulsed electric current of known amplitude and time-occurrence is passed through a transmitter creating a primary electromagnetic field in the space surrounding the coil, including underground. The eddy currents generated in the ground in turn induce a time-varying secondary magnetic field that is sensed by the receiving instrument. In the OFF-period of the transmitter, the magnitude and time-variation of the magnitude of the received signal is proportional to the terrain conductivity. In the ON-period of the transmitter, the received signal is proportional to the conductivity of the terrain and to the transmitted primary signal. The depth of penetration of the electromagnetic field into the subsurface is governed by the subsurface formation conductivity, transmitter power, transmitter excitation frequency, and other factors.

The depth of penetration of an electromagnetic field depends upon its frequency and the electrical conductivity of the medium through which the electromagnetic field is propagating. Electromagnetic fields are attenuated, or weakened, during their passage through the subsurface. The amplitude of the electromagnetic field decreases exponentially with depth. The ease at which a wave penetrates the subsurface increases as both the frequency of the electromagnetic field and the conductivity of the ground decrease. Consequently, the frequency used in an EM survey can be tuned to a desired depth range in any particular medium. Nevertheless, traditional EM survey systems have finite bandwidth.

Accordingly, EM survey systems may be designed with transmitters to transmit energy in a wide range of frequencies, or be as broadband as possible. Similarly, receivers employed in EM survey systems are designed to measure the electromagnetic response for a wide frequency range typically sacrificing low-frequency sensitivity for high-frequency response. The high-frequency end of the electromagnetic spectrum, or range of frequencies, is used to detect subsurface bodies with large electrical resistivity values (and provide near-surface vertical resolution) or whose secondary magnetic field response has a fast decay rate. The low-frequency end of the electromagnetic spectrum is used to detect subsurface bodies with low electrical resistivity values (and provide deeper subsurface exploration) or whose secondary magnetic field response has a slow decay rate.

Current airborne EM survey systems typically use receivers based on induction coils measuring the time rate of change (dB/dt) of magnetic fields resulting in good high-frequency sensitivity but poor low frequency sensitivity. Some systems enhance low-frequency sensitivity by estimating the magnetic field (B-field) from the dB/dt signals but the induction coil's lack of sensitivity to low frequency signals limits the effectiveness of this system. Magnetometers directly measure the magnetic field but they lack sensitivity at high frequencies. Thus, a need has arisen for a system that is capable of directly measuring and combining both the magnetic field and the time rate of change of the magnetic field to provide sufficient sensitivity across the entire frequency range of interest.

### SUMMARY

In accordance with one or more embodiments of the present disclosure, an electromagnetic survey system includes a first receiver configured to sense signals in a first spectrum based on sensing a magnetic field. The system includes a second receiver configured to sense signals in a second spectrum based on sensing a time rate of change of the magnetic field. The second spectrum has a frequency range higher than the first spectrum. The system further includes a transmitter configured to transmit a specified waveform and a control system configured to control the transmitter to transmit the specified waveform. The control system is also configured to receive signals sensed by the first receiver, receive signals sensed by the second receiver, and store the signals received from the first receiver and the signals received from the second receiver.

In accordance with another embodiment of the present disclosure, a method of electromagnetic surveying includes controlling a transmitter to transmit a specified waveform, and receiving signals sensed by a first receiver. The first receiver is configured to sense signals in a first spectrum based on sensing a magnetic field. The method also includes receiving signals sensed by a second receiver. The second receiver is configured to sense signals in a second spectrum based on sensing a time rate of change of the magnetic field. The second spectrum has a frequency range higher than the first spectrum. The method further includes storing the signals received from the first receiver and the signals received from the second receiver.

In accordance with another embodiment of the present disclosure, a composite electromagnetic device includes a first receiver configured to sense electromagnetic signals in a first spectrum based on sensing a magnetic field. The device also includes a second receiver configured to sense electromagnetic signals in a second spectrum based on sensing a time rate of change of the magnetic field. The second spectrum has a higher frequency range than the first spectrum.

### BRIEF DESCRIPTION OF THE DRAWINGS

For a more complete understanding of the present disclosure and its features and advantages, reference is now made to the following description, taken in conjunction with the accompanying drawings, which may include drawings that are not to scale and wherein like reference numbers indicate like features, in which:

FIG. 1 illustrates a comparison of frequency bandwidths for various receivers in accordance with some embodiments of the present disclosure;

FIG. 2 illustrates an exploded view of an exemplary composite electromagnetic device in accordance with some embodiments of the present disclosure;

FIGS. 3A and 3B illustrate exemplary perspective views of an assembly of a composite electromagnetic device in accordance with some embodiments of the present disclosure;

FIG. 4 illustrates a perspective view of an enclosure of a composite electromagnetic device in accordance with some embodiments of the present disclosure;

FIG. 5 illustrates a perspective view of an exemplary composite electromagnetic device survey system in accordance with some embodiments of the present disclosure;

FIG. 6 illustrates a graph of an exemplary transmitter waveform and response from a composite electromagnetic device in accordance with some embodiments of the present disclosure;

FIG. 7 illustrates a graph of an exemplary transmitter waveform and response from a composite electromagnetic device proximate to a target in accordance with some embodiments of the present disclosure;

FIG. 8 illustrates a graph of an exemplary transmitter waveform and response from a composite electromagnetic device proximate to a target and corrected for the transmitter signal in accordance with some embodiments of the present disclosure; and

FIG. 9 illustrates a flow chart of an example method for a composite electromagnetic device survey in accordance with some embodiments of the present disclosure.

### DETAILED DESCRIPTION

The following description of the exemplary embodiments refers to the accompanying drawings. The same reference numbers in different drawings identify the same or similar elements.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

As described previously, in airborne electromagnetic (EM) survey systems, receivers measure signals from subsurface geologic features based on a transmitted signal. Transmitters may transmit signals that range from low-frequency signals, including static or direct-current (DC) fields, to high-frequency signals, for example, greater than approximately 50,000 Hertz (Hz). A high-frequency receiver, for example an induction coil or induction coil array, may be used to measure signals in an EM survey. However, because an induction coil is configured to measure high-frequency signals over a wide bandwidth, an induction coil may have minimal ability to measure low-frequency signals or DC fields. In contrast, low-frequency receivers, such as magnetic field sensors, may be useful for measuring low-frequency signals and DC fields, but have minimal ability to sense high-frequency signals. Thus, in some embodiments, an EM survey may be improved by using a composite electromagnetic device configured to include both high-frequency receivers and low-frequency receivers to obtain information about the subsurface across a broader electromagnetic frequency spectrum.

In some embodiments, a composite electromagnetic device simultaneously samples high-frequency and low-frequency signals using induction coil arrays, as high-frequency receivers, and magnetic field sensors, such as fluxgate and quantum magnetometers, as low-frequency receivers. An EM survey system may merge the high-frequency and low-frequency measurements into a combined single data set to increase the effective bandwidth of the response. In some embodiments, the information from the multiple receivers can be transformed into a single domain to allow simultaneous processing, imaging, or modelling of the data. For example, the high-frequency and low-frequency measurements may be transformed from the time-domain to the frequency-domain using a Fourier transform, or other similar techniques. The transformed data may then be combined in the frequency-domain by leveraging overlapping receiver bandwidths to produce a single combined data set or response function that is sensitive to a wider spectrum of frequency information than the individual receivers alone.

Therefore, according to embodiments of the present disclosure, systems and methods are presented that provide multiple bandwidth EM surveying. An exemplary EM survey system of the present disclosure is capable of measuring both the high-frequency and low-frequency portions of the electromagnetic frequency spectrum with improved data quality, for example, the data may have a higher signal to noise ratio considering the entire frequency spectrum of interest. Measurements may be made using two or more receivers that are sensitive to different portions of the electromagnetic spectrum. Each of the receivers may be optimized to a particular frequency band of interest, thereby providing an improved data set at all frequencies. Thus, in some embodiments, combining both high-frequency and low-frequency receivers in a single time-domain EM survey results in data comprising a larger bandwidth than an EM survey using a single receiver. Embodiments of the present disclosure may be used in any suitable airborne time-domain EM survey system, such as the HELITEM™ system designed and manufactured by CGG Services SA (Massy, France).

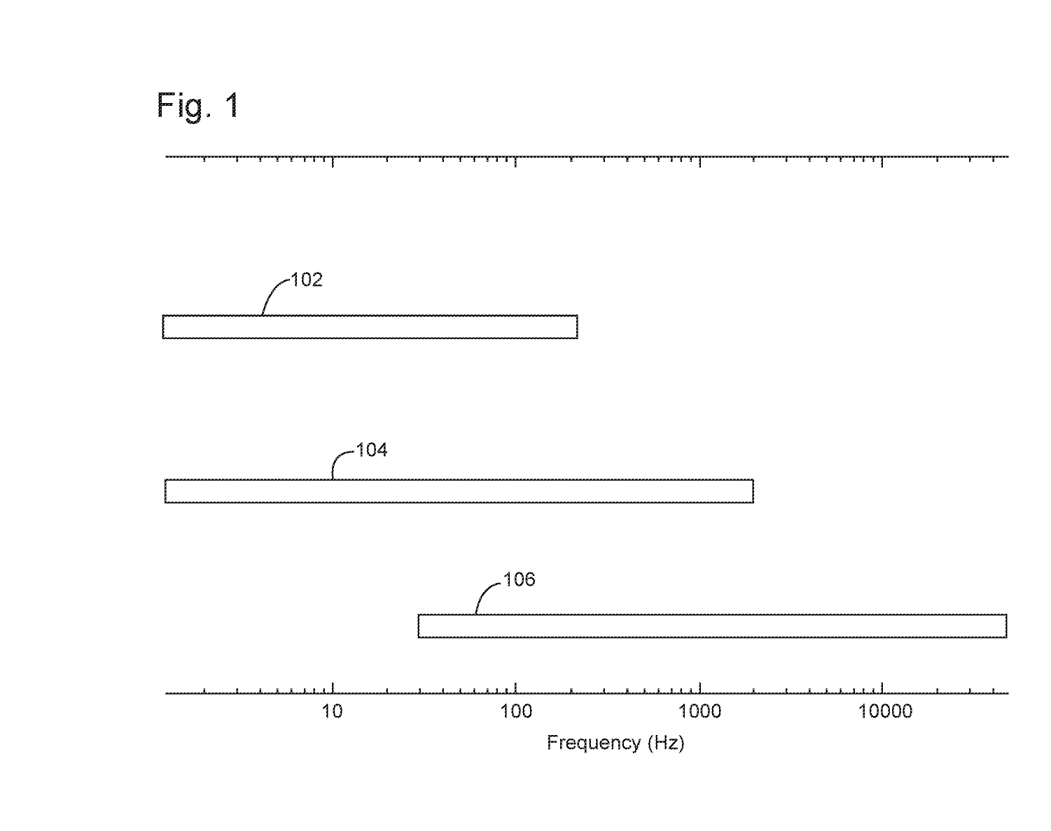

In most airborne electromagnetic time-domain systems, an induction coil array (which measures the time-rate change of the magnetic field, dB/dt) is employed to measure time-varying magnetic fields. As such, induction coils usually have high sensitivity to high-frequency signals but poor sensitivity to low-frequency signals. In contrast, receivers measuring the magnetic field (the B-field) generally have superior low-frequency performance. For example, fluxgate magnetometers have a bandwidth approximately from DC to 2,000 Hz but measurements can be sensitive to thermal variation. Quantum magnetometers have a bandwidth approximately from DC to 200 Hz and also have good thermal stability. Depending on coil properties, induction coil receivers may have bandwidths in the range of approximately 30 to 100,000 Hz or more. Further, induction coils may be designed and constructed such that the bandwidth may be tuned to the frequencies of interest. However, practical induction coils have limited bandwidth and a single induction coil may not have good sensitivity to both high and low frequencies simultaneously. FIG. 1 illustrates a comparison 100 of frequency bandwidths for various receivers in accordance with some embodiments of the present disclosure. Range 102 may correspond to a frequency range for a quantum magnetometer, for example a cesium magnetometer. Range 102 may include a bandwidth from approximately 0 Hz to 200 Hz. Range 104 may correspond to a frequency range for a fluxgate magnetometer. Range 104 may include a bandwidth from approximately 0 Hz to 2,000 Hz. Range 106 may correspond to a frequency range for an induction coil. Range 106 may include a bandwidth from approximately 30 Hz to greater than 100,000 Hz. Any single receiver is bandwidth limited. A single receiver may not be sufficiently sensitive to an entire range for frequencies useful for geophysical surveying. Thus, by performing measurements with a number of receivers with different bandwidths and combining the results, embodiments of the present disclosure are sensitive to signals over a wider range of frequencies.

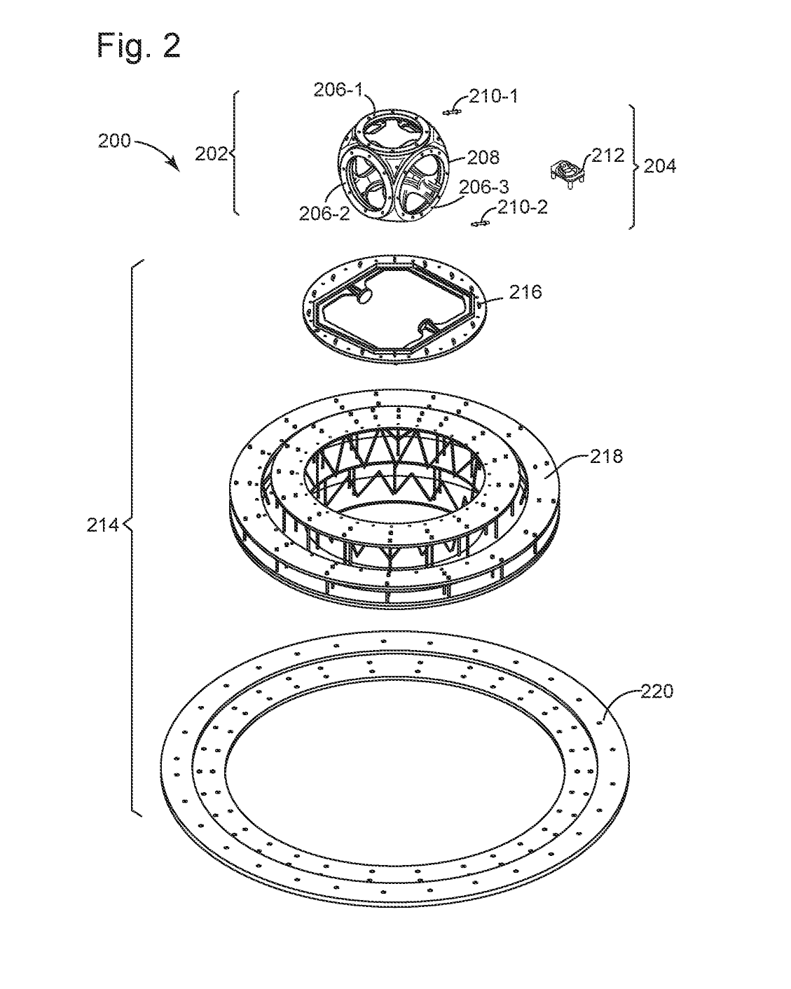

FIG. 2 illustrates an exploded view of an exemplary composite electromagnetic device 200 in accordance with some embodiments of the present disclosure. Composite electromagnetic device 200 may be configured to receive both low-frequency and high-frequency electromagnetic signals. High-frequency electromagnetic signals can be used to detect and characterize subsurface targets with high electrical resistivity or fast magnetic field decay rates and to characterize near-surface layering—layers within, for example, approximately 165 feet or fifty meters of the earth's surface—while also discriminating thin layers within that depth. Low-frequency electromagnetic signals can be used to detect electrically conductive targets or characterize the subsurface beyond the near surface. Composite electromagnetic device 200 includes multiple receivers that receive signals based on an excitation signal emitted by a transmitter. Each receiver may be arranged to receive a different bandwidth of the electromagnetic spectrum. In some embodiments, the receivers may be arranged to measure a partially overlapping bandwidth of the electromagnetic spectrum. For example, one receiver may be optimized to receive electromagnetic signals of relatively high-frequency while another receiver may be optimized to receive relatively low-frequency signals. The bandwidth or frequency spectrum for the high-frequency receivers includes frequencies greater than the frequency spectrum for the low-frequency receivers, but the bandwidths may overlap each other to allow for a continuous bandwidth from low frequency to high frequency to be achieved. The overlap between the frequency bandwidth of each receiver assists in acquiring electromagnetic data covering the range of shallow to mid to deep subsurface formations. Thus, at least two distinct receivers allow for optimization to receive a chosen frequency band of electromagnetic energy. Accordingly, composite electromagnetic device 200 may include high-frequency receivers 202 and low-frequency receivers 204.

High-frequency receivers 202 may be operable to sense, detect, and measure signals with high frequencies, for example greater than approximately 100,000 Hz. In some embodiments, high-frequency receivers 202 include one or more induction coils 206 configured in an induction coil array 208. Induction coils 206-1, 206-2 and 206-3 may be configured singly or in coil pairs with different orientations to measure signals in the x, y, and z-axis orthogonal directions. Although shown as including one induction coil array 208 with three induction coils 206, composite electromagnetic device 200 may include any number of induction coil arrays 208 and induction coils 206 that may be configured to detect different portions of the high-frequency spectrum.

Low-frequency receivers 204 may be operable to sense or detect signals with low frequencies, for example less than approximately 2,000 Hz. In some embodiments, low-frequency receivers 204 may include fluxgate magnetometers 210 and quantum magnetometer 212. Fluxgate magnetometers 210 may include a core wrapped with two coils of wire. Fluxgate magnetometers 210 may be constructed to measure three orthogonal components of the magnetic field in a single sensor. Fluxgate magnetometers 210-1 and 210-2 may be collocated or configured around a common measurement point to provide an averaged measurement at the center location or may be placed singly on the apparatus. Placing the fluxgate magnetometers on the same structure as the induction coils results in the sensors having the same motion and eliminates the need to correct for this motion when the data from the sensors are calibrated and/or combined. Quantum magnetometer 212 may be any type of magnetometer based on various atomic transitions, such as a cesium magnetometer or any other suitable magnetometer based on the application. For example, quantum magnetometer 212 may be an optically pumped alkali vapor magnetometer, such as helium, potassium, or rubidium magnetometers, each having a varied operating bandwidth.

Additionally, composite electromagnetic device 200 may include structural system 214 configured to support and protect high-frequency receivers 202 and low-frequency receivers 204 during operation. For example, structural system 214 may include bracket 216, suspension system 218, support structure 220, and any other components suitable for a particular implementation. In the current example, fluxgate magnetometers 210 may be coupled to a top and a bottom surface of induction coil array 208, which may further be coupled to bracket 216. Bracket 216 may be coupled to suspension system 218 that may be coupled to support structure 220. Additionally, in the current example, quantum magnetometer 212 may be coupled to suspension system 218. Suspension system 218 may be a multi-stage suspension that may be designed to eliminate or minimize any motion energy induced into structural system 214 from influencing the high-frequency and low-frequency receivers. Suspension system 218 may translate or tune any of the motion energy that does influence the receivers into portions of the frequency spectrum that may not affect the data in a negative manner. For example, the motion energy may be translated to a very low frequency or tuned to lower frequencies.

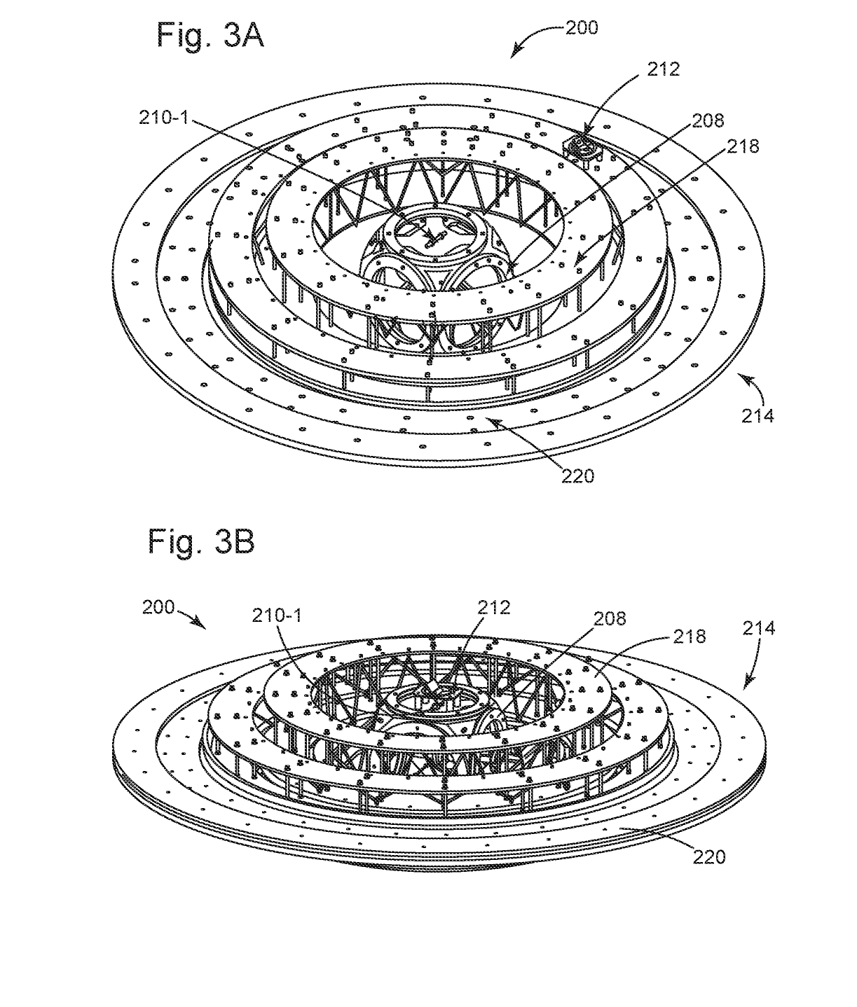

FIG. 3A illustrates an exemplary perspective view of an assembly of composite electromagnetic device 200 in accordance with some embodiments of the present disclosure. Components in composite electromagnetic device 200 may be coupled via any suitable coupling mechanism, for example, screws, rivets, adhesive, or any other type of mechanical coupling. Further, although shown with a particular exemplary structural system 214 and arrangement of components, composite electromagnetic device 200 may be configured with any structural system and arrangement of components as suitable for the particular implementation. FIG. 3B illustrates another exemplary perspective view of an assembly of composite electromagnetic device 200 in accordance with some embodiments of the present disclosure. In FIG. 3B, quantum magnetometer 212 may be coupled to and/or placed proximate to induction coil array 208. Placing the quantum magnetometer 212 on the same stage of suspension system 218 or bracket 216 as induction coil array 208 and fluxgate magnetometers 210 may improve data gathering because their motion experienced by all receivers may be similar. In some embodiments, although not expressly shown, quantum magnetometer 212 may be placed underneath and coupled to induction coils 206, bracket 216, or suspension system 218. Additionally, although shown in FIGS. 3A and 3B as electromagnetic device 200 including one induction coil array 208, one quantum magnetometer 212 and two fluxgate magnetometers 210, embodiments of the present disclosure contemplate any number of high-frequency receivers and low-frequency receivers associated with composite electromagnetic device 200 as required for the particular implementation.

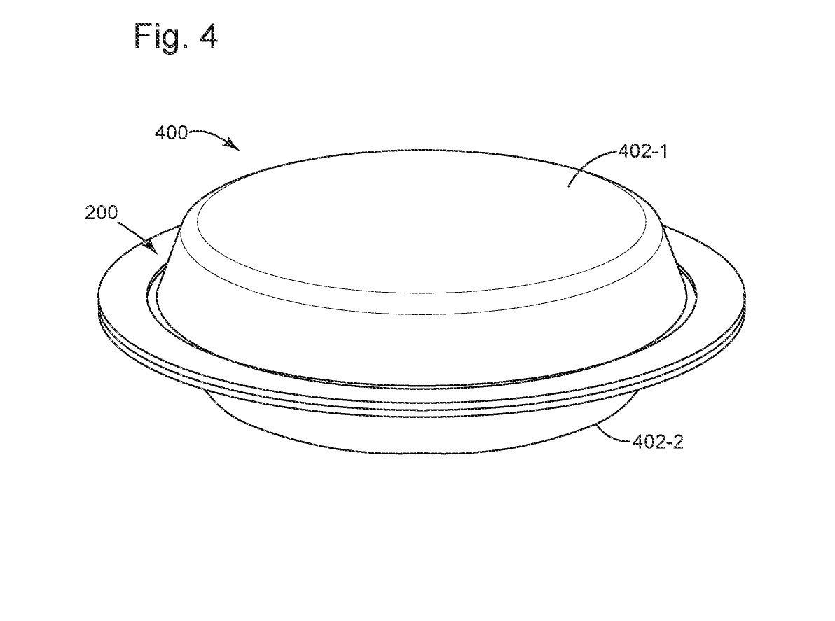

FIG. 4 illustrates a perspective view of enclosure 400 of a composite electromagnetic device in accordance with some embodiments of the present disclosure. Enclosure 400 includes composite electromagnetic device 200 and guards 402-1 and 402-2. Guards 402 may be configured to protect and enclose components of composite electromagnetic device 200. Guards 402 may be constructed of any material and any configuration suitable to provide appropriate protection to composite electromagnetic device 200 without interfering with electromagnetic propagation or otherwise with the operation of device 200.

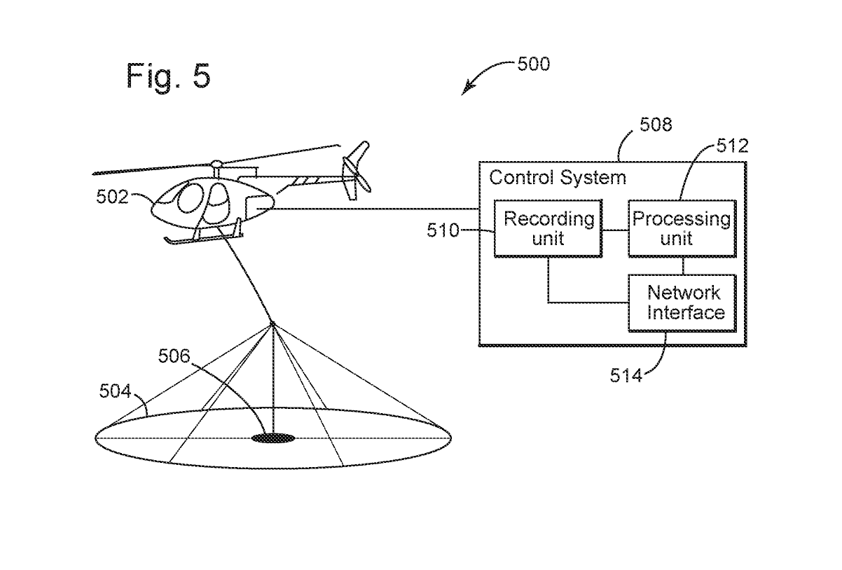

FIG. 5 illustrates a perspective view of a composite electromagnetic device survey system 500 in accordance with some embodiments of the present disclosure. In some embodiments, system 500 may include helicopter 502 that tows transmitter 504 and one or more receivers configured in composite electromagnetic device 506. In some embodiments, composite electromagnetic device 506 may be configured as composite electromagnetic device 200 discussed with reference to FIGS. 2, 3A, 3B, and 4. Although shown with helicopter 502 in the current example, other aircraft may be used in system 500, such as a fixed wing aircraft or some other airborne vehicle. The helicopter, fixed-wing aircraft, or other airborne vehicle may be manned or unmanned. Although illustrated with one helicopter 502, multiple helicopters 502 may be utilized in system 500 or a multitude of transmitters and receivers with different bandwidths may be utilized. Further, helicopter 502 or other aircraft may be configured to make one or more passes over a defined exploration area as suitable for a particular survey. A positioning system, such as a global positioning system (GPS), may be utilized to locate or time-correlate the movements of helicopter 502 with reference to the exploration area. Further, although an embodiment is depicted and described with an airborne system, the systems and methods of the present disclosure could also be applied to land-based or marine-based systems.

Transmitter 504 may include a housing or tube structure supporting one or more turns of electrically conductive wire or tube forming a coil. The transmitter loop may be a substantially circular form that may be suspended from helicopter 502. Alternatively, the transmitter loop may be a square, diamond, rectangle, or other polygonal shape. As example, transmitter 504 may include approximately ten turns of coil wound on an approximately one meter diameter circular form. Further, transmitter 504 may be separated from nearby air vehicles in order to reduce noise from coupling between the system and the vehicle. In some embodiments, transmitter 504 may be towed below or below and behind a fixed-wing aircraft or balloon or other airborne vehicle in place of helicopter 502, such that transmitter 504 is separated by some distance from the aircraft. Transmitter 504 may transmit a signal received from a signal generator configured in control system 508. The signal received from the signal generator may employ a trapezoid waveform, a sinusoidal waveform, a square waveform, or any other waveform or combination of waveforms suitable for a particular application.

Composite electromagnetic device 506 may be disposed substantially at the center of the loop formed by transmitter 504. In some embodiments, composite electromagnetic device 506 may be disposed at some distance above transmitter 504 and below helicopter 502. In another embodiment, composite electromagnetic device 506 may be placed at the apex of the set of cables supporting transmitter 504 or other set of cables.

Control system 508 may be configured to transmit a signal to transmitter 504. Control system 508 may include a signal generator that may be any type of device, software, hardware, or firmware that generates controlled electrical signals used to perform EM surveys. Control system 508 may also be configured to receive and record signals from receivers disposed in composite electromagnetic device 506. Control system 508 may further be configured to transmit recorded signals and other data to other computing systems, produce imaging of the earth's subsurface geological formations, or perform any other functions related to an EM survey. Control system 508 may include one or more recording units 510, one or more processing units 512, and network interface 514. In some embodiments, control system 508 may be located remotely from helicopter 502 or other towing aircraft.

Recording unit 510 may be communicatively coupled to processing unit 512, network interface 514, composite electromagnetic device 506, and transmitter 504. One or more receivers disposed in composite electromagnetic device 506 may transmit raw data of the received electromagnetic energy via network interface 514 to recording unit 510. Recording unit 510 may transmit raw electromagnetic data or processed electromagnetic data to processing unit 512 or other processing system via network interface 514. Processing unit 512 is operable to generate signals to be transmitted by transmitter 504, and perform electromagnetic data processing on the raw electromagnetic data from composite electromagnetic device 506 to prepare the data for interpretation. Although discussed separately, recording unit 510 and processing unit 512 may be configured as separate units or as a single unit. Recording unit 510 or processing unit 512 may include any instrumentality or aggregation of instrumentalities operable to compute, classify, process, transmit, receive, store, display, record, or utilize any form of information, intelligence, or data. For example, recording unit 510 and processing unit 512 may include one or more personal computers, storage devices, servers, or any other suitable device and may vary in size, shape, performance, functionality, and price. Recording unit 510 and processing unit 512 may include random access memory (RAM), one or more processing resources, such as a central processing unit (CPU) or hardware or software control logic, or other types of volatile or non-volatile memory. Additional components of recording unit 510 and processing unit 512 may include one or more disk drives, one or more network ports for communicating with external devices, one or more input/output (I/O) devices, such as a keyboard, a mouse, or a video display.

Network interface 514 may be configured to communicatively couple one or more components of control system 508 with any other component of system 500. For example, network interface 514 may communicatively couple transmitter 504 and composite electromagnetic device 506 with recording unit 510 and processing unit 512. Further, network interface 514 may be any type of network that provides communication, such as one or more of a wireless network, a local area network (LAN), or a wide area network (WAN), such as the Internet.

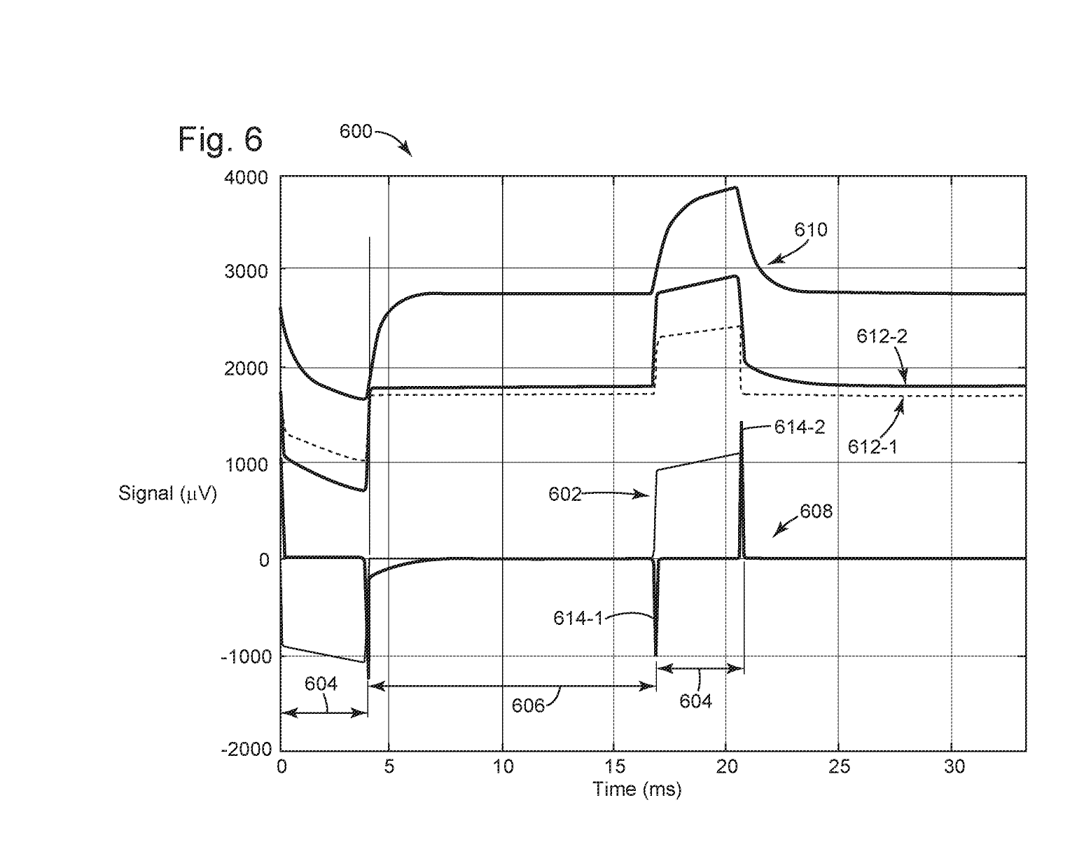

FIG. 6 illustrates graph 600 of an exemplary transmitter waveform 602 and response from a composite electromagnetic device in accordance with some embodiments of the present disclosure. An EM survey system includes a transmitter (for example, transmitter 504 discussed with reference to FIG. 5) for transmitting signals having a waveform 602. Waveform 602 may include a pulse that corresponds to ON-period 604. In some embodiments, the EM survey system also includes multiple receivers. For example, as discussed with reference to FIGS. 2 through 4, receivers may include induction coil array 208, fluxgate magnetometers 210-1 and 210-2, and quantum magnetometer 212. Each receiver of the EM survey system measures the response from waveform 602 during and after each ON-period 604. Transmitter waveform 602 may be generated using one or more signal generators associated with control system 508.

As depicted in FIG. 6, waveform 602 may include, for example, negative square pulses during ON-period 604, separated by an OFF-period 606 and positive square pulses in the next ON-period 604. In other embodiments, waveform 602 may consist of a series of positive and negative half sine pulses followed by a series of positive and negative square or trapezoidal pulses, or any combination of pulses at the same or varied power levels.

In some embodiments, graph 600 also illustrates the response from receivers configured in a composite electromagnetic device. Induction coil array response 608 may be based on the signal received at an induction coil array, such as induction coil 208 shown in FIGS. 2, 3A and 3B. Quantum magnetometer response 610 may be based on the signal received at a quantum magnetometer (for example a cesium magnetometer), such as quantum magnetometer 212. Fluxgate magnetometer responses 612-1 and 612-2 (for simplicity, only one component from each three-component receiver is shown) may correspond to signals received at fluxgate magnetometers that may be located at different positions within composite electromagnetic device 200, for example fluxgate magnetometers 210-1 and 210-2, respectively.

As illustrated in FIG. 6, induction coil array response 608 may exhibit peaks 614-1 and 614-2 based on the time-derivative of the square pulse during ON-period 604 due to switching from OFF to ON and ON to OFF. During the ON-period 604, induction coil array response 608 may be approximately zero. Fluxgate magnetometer responses 512 may approximate a square pulse shape with slightly impaired fidelity at the transition points. Since fluxgate magnetometers measure magnetic field, during the ON period the reading is not zero but is proportional to the transmitter primary field. Because of its relatively poor high frequency performance, the quantum magnetometer response 610 may respond to the square pulse during ON-period 604 with a waveform that may poorly approximate a square pulse, resulting in filtered response to the transition events, e.g., turning the signal ON and OFF. As such, quantum magnetometer response 610 may exhibit a relatively poor high-frequency performance compared to induction coil array response 608.

Accordingly, FIG. 6 illustrates that high-frequency receivers, such as induction coil arrays, at early delay times (for example, times shortly after the square pulse is turned OFF), may be useful for obtaining high-frequency information. Thus, the self-response time of the high-frequency receivers and the time length of the signal turn-OFF may need to be minimized to optimize the high-frequency response. The design and configuration of the high-frequency receivers may minimize the self-response time, for example, by having an induction coil array with a small turns-area. By designing a transmitter with fewer turns, the current from the transmitter may be turned OFF quickly, such that higher-frequency energy is excited into the ground.

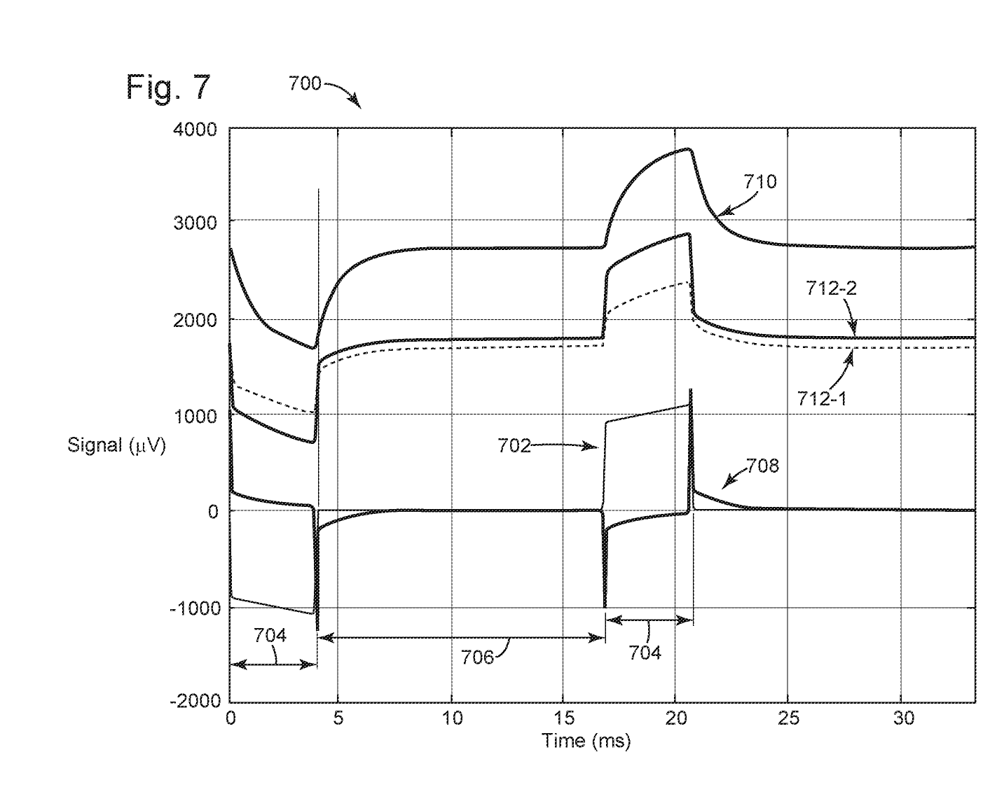

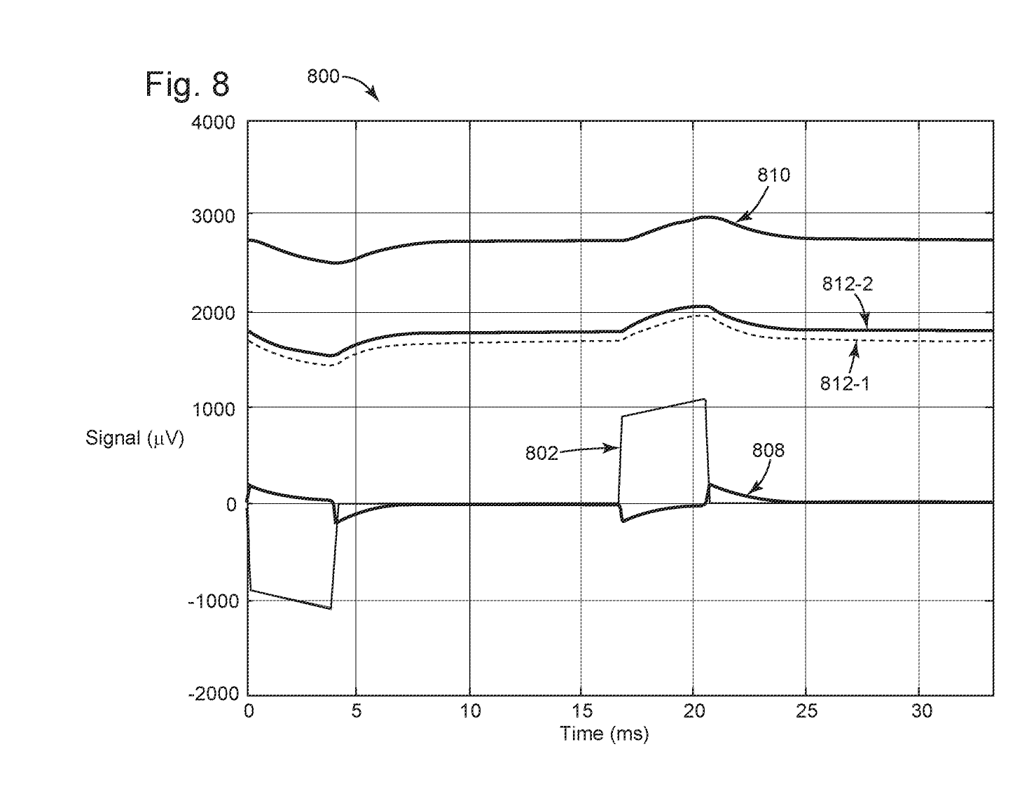

FIG. 7 illustrates graph 700 of an exemplary transmitter waveform 702 and response from a composite electromagnetic device proximate to a target in accordance with some embodiments of the present disclosure. The responses in FIG. 7 differ from FIG. 6 due to the introduction of a conductive target that responds to the signal sent by the transmitter and generates a secondary response. In induction coil array response 708, a small distortion of the signal may be visible during ON-period 704. However, quantum magnetometer response 710 may exhibit a much larger distortion during ON-period 704. The fluxgate magnetometers may have relatively greater high-frequency sensitivity than the quantum magnetometers reading, but relatively less high-frequency sensitivity than the induction coils. For clarity, FIG. 8 illustrates graph 800 of an exemplary transmitter waveform 802 and response from a composite electromagnetic device proximate to a target and corrected for the transmitter signal in accordance with some embodiments of the present disclosure. The responses in FIG. 8 differ from the FIG. 7 because the impact of transmitter waveform 802 is removed from each of the responses: induction coil array response 808, quantum magnetometer response 810, and fluxgate magnetometer responses 812-1 and 812-2

As noted previously, sensitivity to conductive targets is generally higher by measurement of the magnetic field rather than the time derivative. Because quantum and fluxgate magnetometers—which measure the B-field instead of dB/dt—are utilized in the composite electromagnetic device, improved resolution of the response to the transmitted signal may be achieved over the use of induction coil arrays—which measure dB/dt and are transformed to B-field—when the transmitted signal impacts a conductive target and returns low-frequency response signals. Thus, by combining measurements from multiple receivers, an EM survey system using a composite electromagnetic device may have improved resolution of the signal from targets of differing electrical properties.

In some embodiments, the induction coil array dB/dt readings may be transformed to a B-field reading to improve high-frequency information of the B-field measurement. Alternatively, the magnetometer readings may be transformed to dB/dt readings to improve the low-frequency information of the dB/dt measurements. Once measurements have been transformed to same domain, the multiple measurements may be merged into a single measurement that has improved spectral content than either of the B-field or dB/dt readings alone. It should be noted that, in some embodiments, the information from the fluxgate magnetometers and induction coils, which are prone to drift because of sensitivity to thermal variation, may be calibrated by using the overlapping information from the other receivers. For example, low-frequency information can be calibrated using the quantum magnetometer. For each frequency of interest, calculations may be made for a correction factor based on the known sensor sensitivity and the measured signal. The correction factor may allow for calibration dynamically and provide a thermally sensitive B-field (or dB/dt) estimate. In some embodiments, a frequency dependent curve may be fit to the measured data to extrapolate a correction factor for frequencies higher than the quantum magnetometer bandwidth.

Data from each EM survey may be used independently for processing, interpretation, modelling, or transforming from data to electrical properties or to geology. Using at least two receivers, one configured for low-frequency signals and one configured for high-frequency signals, may provide improved measurement of a wider range of frequencies. Accordingly, more accurate and robust information regarding subsurface formations may be obtained by combining the data from the two or more receivers and performing simultaneous processing, modelling, or transforming the data to electrical properties or geology. Further, modelling or interpreting data from one of the receivers and subsequent modelling or interpretation of data from the other receivers based on the results from the first receiver may also improve the interpretation, model, or product. For example, the data from each of the low-frequency and high-frequency receivers may be cross-correlated for improved signal noise reduction. Additionally the different bandwidths may be used to calibrate the overall system response. For example, the measured response, e.g., received signals, may be normalized by the receiver bandwidth and/or calibrated in the frequency domain by using information in the overlapping spectra.

In some embodiments, the composite electromagnetic device system includes a method to combine the band-limited measurements from each separate receiver into a single data stream with a much wider bandwidth than any individual receiver. The measured data may be transformed into the frequency domain using a discrete Fourier transform and, normalizing or otherwise accounting for the known or measured spectral response of each receiver, be combined in the Fourier domain. The combined Fourier-domain data can then be inverse Fourier-transformed to the time domain to yield a combined data set with superior frequency content than any of the individual receivers.

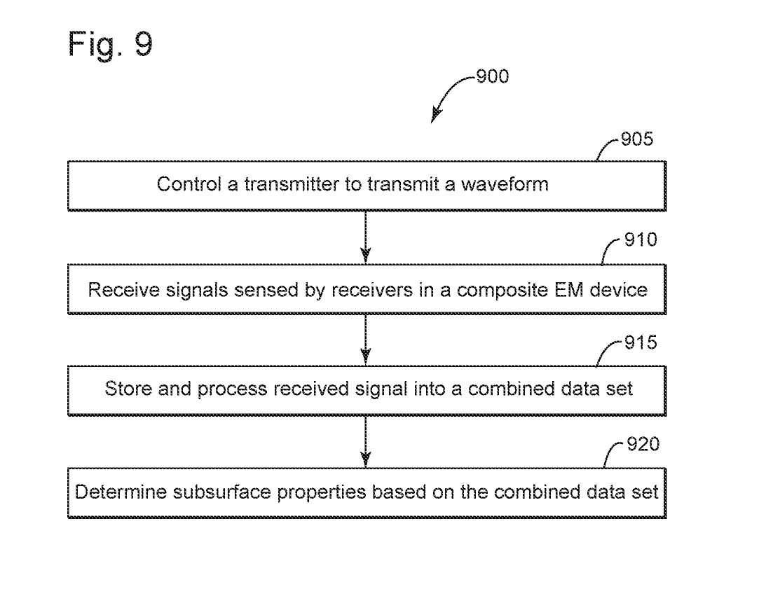

FIG. 9 illustrates a flow chart of an example method 900 for a composite electromagnetic device survey in accordance with some embodiments of the present disclosure. The steps of method 900 are performed by a user, various computer programs, models configured to process or analyze geophysical data, and combinations thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze geophysical data may be referred to as a “computing system.” For illustrative purposes, method 900 is described with respect to data based on control system 508 of FIG. 5; however, method 900 may be used for any composite electromagnetic device surveys. A particular survey may include many cycles of transmitting and receiving electromagnetic signals and is not limited to any order of processes described herein.

In step 905, the computing system controls a transmitter to transmit a waveform. The waveform may be a square wave transmitted by a transmitter as described with reference to FIGS. 6, 7, and 8. In some embodiments, the waveform transmitted may include any other wave shape, such as sine pulses or trapezoidal pulses.

In step 910, the computing system receives signals sensed by receivers in a composite electromagnetic device. For example, as discussed with reference to FIGS. 2, 3A and 3B, receivers in the composite electromagnetic device may include high-frequency receivers, such as an induction coil array, and low-frequency receivers, such as quantum and fluxgate magnetometers.

In step 915, the computing device stores and processes the received signals into a combined data set. As discussed with reference to FIGS. 7 and 8, the signals from the multiple receivers may be stored on a computing device for later processing. The stored signals may be merged into a single data stream via a Fourier transform. At least a subset of the received signals may be transformed into the frequency domain using a discrete Fourier transform. The data may be normalized or otherwise corrected for the spectral response of each receiver. The data may be merged into one data stream in the frequency domain and then processed with an inverse Fourier transform back to the time-domain. Further processing may combine the data from the multiple receivers to yield a combined data set with improved frequency content than that obtained from individual receivers. Alternatively, the raw data from the received signals may be stored for processing at a later time.

In step 920, the computing device determines subsurface properties based on the combined data set. For example, based on the combined data set, subsurface properties from surface to varying depths beneath the surface may be determined and a model may be generated.

Additionally, modifications, additions, or omissions may be made to method 900 without departing from the scope of the present disclosure. For example, the order of the steps may be performed in a different manner than that described and some steps may be performed at the same time. Additionally, each individual step may include additional steps without departing from the scope of the present disclosure.

The foregoing detailed description does not limit the disclosure. Instead, the scope of the disclosure is defined by the appended claims. The described embodiments are not limited to the disclosed configurations, and may be extended to other arrangements.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a receiver does not have to be turned on but must be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. For example, the transmitting waveform, receiving sensed signals, and processing of received signals processes may be performed through execution of computer program code in a computer-readable medium.

Embodiments of the present disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium or any type of media suitable for storing electronic instructions, and coupled to a computer system bus. Furthermore, any computing systems referred to in the specification may include a single processor or may be architectures employing multiple processor designs for increased computing capability.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the present disclosure is defined by the appended claims.

1. An electromagnetic survey system comprising:
a first receiver configured to sense signals in a first spectrum based on sensing a magnetic field;
a second receiver configured to sense signals in a second spectrum based on sensing a time rate of change of the magnetic field, the second spectrum having a frequency range higher than the first spectrum;
a transmitter configured to transmit a specified waveform;
a control system configured to:
control the transmitter to transmit the specified waveform;
receive signals sensed by the first receiver;
receive signals sensed by the second receiver; and
store the signals received from the first receiver and the signals received from the second receiver.

2. The system of claim 1, wherein the control system is further configured to process the stored signals into a combined data set.

3. The system of claim 2, wherein the control system is further configured to determine subsurface properties based on the combined data set.

4. The system of claim 2, wherein processing the received signals into the combined data set comprises transforming at least a subset of the received signals into the frequency domain using a Fourier transform.

5. The system of claim 4, wherein processing the received signals into the combined data set further comprises merging the received signals in the frequency domain.

6. The system of claim 5, wherein processing the received signals into the combined data set further comprises transforming the combined received signals into the time domain using an inverse Fourier transform.

7. The system of claim 1, wherein the second receiver comprises an induction coil array.

8. The system of claim 1, wherein the first receiver comprises a quantum magnetometer.

9. The system of claim 1, wherein the first receiver comprises an optically pumped alkali vapor magnetometer.

10. The system of claim 1, further comprising a third receiver.

11. The system of claim 10, wherein the third receiver comprises two fluxgate magnetometers, the two fluxgate magnetometer configured orthogonally.

12. The system of claim 10, wherein the two fluxgate magnetometers comprise three-axis fluxgate magnetometers and are configured relative to a common measurement point.

13. (canceled)

14. (canceled)

15. A method of electromagnetic surveying, comprising:
controlling a transmitter to transmit a specified waveform;
receiving signals sensed by a first receiver, the first receiver configured to sense signals in a first spectrum based on sensing a magnetic field;
receiving signals sensed by a second receiver, the second receiver configured to sense signals in a second spectrum based on sensing a time rate of change of the magnetic field, the second spectrum having a frequency range higher than the first spectrum; and
storing the signals received from the first receiver and the signals received from the second receiver.

16. The method of claim 15, further comprising processing the stored signals into a combined data set.

17. The method of claim 16 further comprising determining subsurface properties based on the combined data set.

18. The method of claim 16, wherein processing the received signals into the combined data set comprises transforming at least a subset of the received signals into a frequency domain using a Fourier transform.

19. The method of claim 18, wherein processing the received signals into the combined data set further comprises merging the received signals in the frequency domain.

20. The method of claim 19, wherein processing the received signals into the combined data set further comprises transforming the combined received signals into a time domain using an inverse Fourier transform.

21. A composite electromagnetic device comprising:
a first receiver configured to sense electromagnetic signals in a first spectrum based on sensing a magnetic field; and
a second receiver configured to sense electromagnetic signals in a second spectrum based on sensing a time rate of change of the magnetic field, the second spectrum having a higher frequency range than the first spectrum.

22. The device of claim 21, wherein the second receiver comprises an induction coil array and the first receiver comprises a quantum magnetometer.
